(19) United States
(12) Patent Application Publication
(10) Pub. No.: US 2024/0151861 A1
(43) Pub. Date: May 9, 2024

(54) SCINTIGRAPHIC DETECTION DEVICE WITH A HIGH DEGREE OF COMPACTNESS AND SIMPLIFIED ELECTRONICS

(71) Applicant: CONSIGLIO NAZIONALE DELLE RICERCHE, Roma (IT)

(72) Inventors: Alessandro SOLURI, Roma (IT); Roberto MASSARI, Nettuno (RM) (IT)

(21) Appl. No.: 18/279,791

(22) PCT Filed: Mar. 4, 2022
(86) PCT No.: PCT/IB2022/051917

§ 371 Date: Aug. 31, 2023

(30) Foreign Application Priority Data
Mar. 10, 2021 (IT) 102021000005549

(51) Int. Cl. G01T 1/20; G01T 1/202

(52) U.S. Cl. CPC G01T 1/20185; G01T 1/202

(57) ABSTRACT

Described is a scintigraphic detection device with a high degree of compactness and simplified electronics, including a scintillation structure, a collimator, an optoelectronic unit associated with the scintillation structure for converting photons into electrical signals and an electronic processing unit connected to the optoelectronic unit for processing the electrical signals generated by the optoelectronic unit, wherein the optoelectronic unit includes a plurality of individual optoelectronic conversion elements of the SiPM or MPPC type each associated with a respective collimation channel and having a surface below the transversal surface of the respective collimation channel, and wherein between each optoelectronic conversion element and the scintillation structure there is an optical guide configured for conveying and for converging the photons generated by a corresponding portion of the scintillation structure towards the optoelectronic conversion element.

### CROSS-REFERENCE TO RELATED APPLICATIONS

This application is the US national stage of PCT/IB2022/051917, filed Mar. 4, 2022 and designating the U.S., which claims the priority of IT 102021000005549, filed Mar. 10, 2021. The entire contents of each foregoing application are incorporated herein by reference.

### BACKGROUND OF THE INVENTION

### Field of the Invention

This invention relates to a scintigraphic detection device with a high degree of compactness and simplified electronics, in particular modular, with a high spatial resolution and able to form investigation areas of various shapes and sizes and therefore able to be used in different types of applications.

### Description of the Related Art

In general, the functional imaging systems used (SPECT E PET) are used in Nuclear Medicine as diagnostic devices and, in some cases, as localisation systems in the operating room and robotic surgery. The use of these devices may also be applied in the scintigraphic analysis of organs of small animals, so as to trial new radio-marked antibodies, which are specific for certain diseases. Moreover, there application can be planned in safety sectors (airports) or for industrial diagnostics.

The main use of these devices relates to the localisation of tumoral lesions, especially in those techniques which require an adequate spatial precision such as biopsies (prostate and breast) or in radioguided surgical operations or as a monitoring system in radiometabolic therapy, radioguided robot-assisted surgery and small animal imaging applications.

Currently, the devices such as traditional gamma chambers use a large number of phototubes connected together which are designed to read the charge produced in the interaction of the scintillation crystals with the photons coming from the emission source. In general, each phototube records a collected charge value and, consequently, this information is useful for determining the position of the interacting events (photon) in such a way as to form the scintigraphic image.

Over the years several solutions have been introduced linked to the introduction of particular position-sensitive phototubes (PSPMT, “Position Sensitive Photo Multiplier Tube”), that is to say, which is able to calculate the position of the event directly on the same phototube, as an alternative to the simultaneous reading of the charge collected on the various phototubes.

The scintigraphic devices with high spatial resolution may use position-sensitive phototubes of the latest generation, that is to say, devices in which the number and size of the collection anodes may influence the intrinsic precision of the device in terms of spatial resolution which can be achieved. These devices highlight a high resolution power in the more central zones of the phototubes whilst this feature is not maintained close to the edges, due to a smaller collection of light due to the lack of sufficient anodes to complete the entire process for collecting the charge close to these zones. The physical dimensions of the device in general do not coincide with the collection area, therefore close to the edge zones the charge collection is incomplete caused by the loss of a portion of light due to the absence of more external collection anodes. The use of diffuser means (glass, quartz, etc.) is suitable for increasing the widening of the light which is produced in the crystal, since this method is effective in coupling several phototubes alongside each other, in order to better distribute it on several contiguous anodes, belonging to various phototubes and consequently perform the calculation of the charge barycentre to determine the position of the event.

The limitation of this technique consists in the actual dimensions of the phototube, which do not exactly correspond to the anode area, the latter being slightly smaller. This results in the presence of a dead zone of a few millimetres on each side when several phototubes are placed alongside each other and, consequently, the need to introduce the necessary measures which, in fact, do not allow satisfactory results to be obtained.

The considerations described up to complicate the development of extended areas by means of a high resolution detection system based on PSPMT phototubes without intervening with processes which are able to provide good results even if affected by limitations regarding the spatial resolution values which can be obtained.

Moreover, the systems using PSPMT phototubes are penalised by the overall dimensions of the latter which, in the case of very large areas, require excessive spaces for their housing (or in any case incompatible with the modern miniaturisation requirements).

As an alternative to the use of PSMPT, recent improvements have been obtained on optoelectronic devices such as APDs (Avalanche Photo Diode) or other types such as SiPMs (Silicon PhotoMultiplier) and similar devices known as MPPC (Multi-Pixel Photon Counter). Compared with traditional PMT phototubes, they have numerous advantages such as, for example, the low operating voltage (from 30 to 80 V depending on the model and the manufacturer) and the insensitiveness to the magnetic field having been tested up to 4 T without any degradation of performance. Their main application limit is the statistical thermal noise (or “dark current”, since it is also present in conditions of non-illumination of the SiPM), which is almost proportional to the active area. This currently places a clear limitation to the production of a single large device which uses a large number of SiPM (or MPPC modules) to create large detection areas.

In effect, in order to obtain an excellent spatial resolution it is necessary to use a large number of SiPM or MPPC elements to cover entirely the detection area; however, this results in an increase in the computational task of analysing the readings in the case of reading the individual elements.

Moreover, in the case of “mediated” readings, that is to say, readings of signals common to a certain number of SiPM or MPPC elements, there is the disadvantage of also adding up the dark currents which, upon reaching a certain number of elements (in the order of several hundreds), determine an overall reading comparable to the reading corresponding to a scintigraphic event (photon), making it impossible to distinguish between a scintigraphic event and a simple background noise amplified by the joining of a plurality of SiPM or MPPC elements connected in series.

### SUMMARY OF THE INVENTION

In consideration of the above-mentioned prior art, the aim of the invention is to provide a scintigraphic detection device which is structurally simple and with a particular simplification of the electronic part.

Another aim of the invention is to provide a scintigraphic detection device which is physically compact, and hence with small dimensions.

Further features and advantages of the invention are more apparent in the non-limiting description which follows of a non-exclusive embodiment of a scintigraphic detection device according to the invention.

The description is set out below with reference to FIG. 1 provided solely for purposes of illustration without restricting the scope of the invention and which shows an embodiment of a scintigraphic detection device made according to the invention.

### BRIEF DESCRIPTION OF THE SOLE DRAWING

FIG. 1 illustrates a schematic view of an embodiment of the scintigraphic detection device of the present invention.

### DETAILED DESCRIPTION

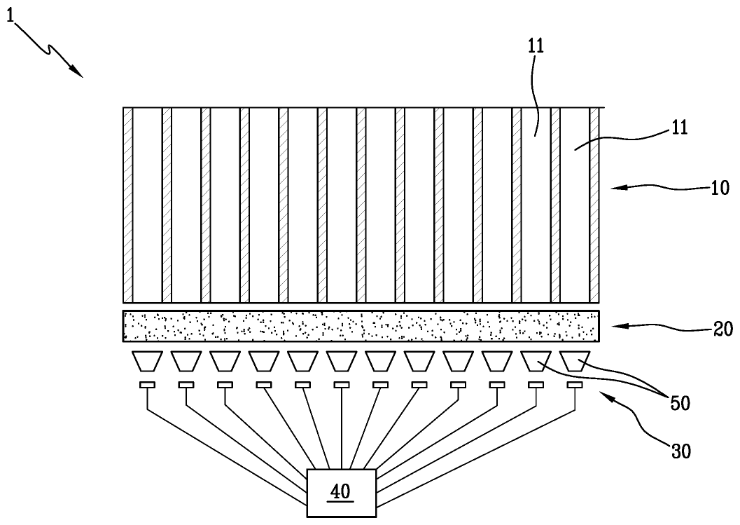

With reference to FIG. 1, the numeral 1 schematically denotes a scintigraphic detection device according to the invention.

The device basically comprises:
a collimator 10;
a scintillation structure 20 configured to convert a radiation into photons, associated with the collimator 10 and positioned below it to define a detection area;
an optoelectronic unit 30 associated with the scintillation structure 20 for converting photons into electrical signals;
an electronic processing unit 40 connected to the optoelectronic unit 30 for processing the electrical signals generated by the optoelectronic unit 30.

With reference to the collimator 10, it is made of a material with a high atomic number and has a plurality of collimation channels 11 distributed on the above-mentioned detection area (for example, according to a two-dimensional distribution) for absorbing the lateral radiation directed towards the scintillation structure 20 and having an angle of incidence greater than a predetermined value.

The collimator 10 may be made in a traditional manner and will not be described further in the prior art aspects.

With reference to the scintillation structure 20, it has a surface extension such as to define an overall detection area, which is preferably substantially equal to the area of extension of the collimator 10.

The scintillation structure 20 is configured to receive a radiation passing through the collimator 10 and to convert the radiation into photons.

According to an embodiment, illustrated in FIG. 1, the scintillation structure 20 comprises a single scintillation plate which extends over the entire overall detection area.

According to a variant embodiment not illustrated, the scintillation structure 20 comprises two or more scintillation plates positioned side by side (laterally) linearly or in a two-dimensional configuration and each associated with a plurality of collimation channels, for example to obtain a modular configuration provided with a number of scintillation plates as a function of the extension of the overall detection area.

According to a further variant embodiment not illustrated, the scintillation structure 20 comprises a matrix of scintillation crystals defining the overall detection area and each associated with a single respective collimation channel 11. For this reason, each scintillation crystal is associated with a single respective collimation channel 11, and each collimation channel 11 is associated with a single respective scintillation crystal, defining a biunique correspondence.

The scintillation plate (or the scintillation crystals in the case of production using individual crystals) is made in known manner, for example using CsI(Tl) or NaI(Tl). Moreover, the radiation is of the gamma type.

With reference to the optoelectronic unit 30, it is positioned below the scintillation unit 20, in other words on the opposite side relative to the collimator 11. This invention relates mainly to the structure of the optoelectronic unit 30.

In particular, according to the invention, the optoelectronic unit 30 comprises a plurality of optoelectronic conversion elements 31 each associated with a respective collimation channel 11 and preferably having a surface lower than the transversal surface of the respective collimation channel 11. For this reason, each optoelectronic conversion element 31 is associated with a single respective collimation channel 11 (and with a single scintillation crystal, where present), and each collimation channel 11 is associated with a single respective optoelectronic conversion element 31, defining a biunique correspondence.

Advantageously, each optoelectronic conversion element 31 comprises a single “Multi Pixel Photon Counter” (MPPC) or “Silicon PhotoMultiplier” (SiPM) element which is preferably directly connected to the electronic processing unit 40. In this way, therefore, each collimation channel 11 is associated with a single SiPC or MPPC element 31.

Preferably, the SiPM or MPPC elements 31 are connected to the electronic processing unit 40 independently of each other. In other words, each SiPM or MPPC element 31 is connected to the electronic processing unit 40 without correlation to the other SiPM or MPPC elements 31 in such a way that the electronic processing unit 40 can receive the electrical signals from each SiPM or MPPC element 31 and process them without interference by the other SiPM or MPPC elements 31.

Preferably, each SiPM or MPPC element 31 is positioned in a centred position relative to the corresponding collimation channel 11.

Preferably, each SiPM or MPPC element 31 has a surface extension of between 1 mm² and 6 mm² and/or each SiPM or MPPC elements 31 has at least a linear dimension less than or equal to half the corresponding linear dimension of the respective collimation channel 11, (for example the width).

Advantageously, the device 1 also comprises, between each SiPM or MPPC element 31 and the scintillation structure 20, an optical guide 50 configured for conveying and for converging the photons generated by a corresponding portion of the scintillation structure towards the SiPM or MPPC element 31. In this way, the radiation passing through a single collimation channel 11 is conveyed in a convergent fashion towards the single and respective SiPM or MPPC element 31, its dimension which is smaller than the collimation channel 11 not adversely affecting the light reading.

Preferably, the optical guides 50 associated with the collimation channels 11 are aligned in a shared plane defining a conveying stage of the photons positioned below the scintillation structure 20 and in particular interposed between the scintillation structure 20 and the optoelectronic unit 30.

According to an embodiment, the optical guides 50 are independent of each other and applied individually to the respective SiPM or MPPC element 31 or to the scintillation structure 20 (therefore, to the respective crystal or to the scintillation plate).

According to a different embodiment, the optical guides 50 are mounted on a shared support which is fixed to the frame of the device 1.

The present invention achieves the preset aims, overcoming the disadvantages of the prior art.

The making of the optoelectronic unit using individual SiPM or MPPC elements improves the overall compactness of the device, also allowing a reliable measurement thanks to the independence of the individual MPPC or SiPM elements, which reduces the incidence of dark currents, the extent of which is certainly negligible compared with the photon event measured.

Moreover, the device is simplified structurally and therefore inexpensive.

1. A scintigraphic detection device which is very compact and has simplified electronics, comprising:
a scintillation structure defining an overall detection area and designed to receive a radiation and to convert said radiation into photons;
a collimator made of a material with a high atomic number and having a plurality of collimation channels distributed over said detection area, said collimator being associated with the scintillation structure for absorbing a lateral radiation directed towards the detection structure and having an angle of incidence greater than a predetermined value;
an optoelectronic unit associated with the scintillation structure for converting photons into electrical signals;
an electronic processing unit connected to the optoelectronic unit for processing the electrical signals generated by the optoelectronic unit;
wherein
the optoelectronic unit comprises a plurality of optoelectronic conversion elements each associated with a respective collimation channel and having a surface lower than the transversal surface of the respective collimation channel, each optoelectronic conversion element comprising a single SiPM or MPPC element,
and wherein
it comprises, between each optoelectronic conversion element and the scintillation structure, an optical guide configured for conveying and for converging the photons generated by a corresponding portion of the scintillation structure towards the optoelectronic conversion element.

2. The device according to claim 1, wherein the scintillation structure comprises a scintillation plate associated with a plurality of said collimation channels.

3. The device according to claim 1, wherein said scintillation structure comprises a matrix of scintillation crystals defining said detection area.

4. The device according to claim 1, wherein each SiPM or MPPC element is positioned in a centred position relative to the corresponding collimation channel.

5. The device according to claim 1, wherein each of said SiPM or MPPC elements has a surface extension of between 1 mm² and 6 mm² and/or wherein each of said SiPM or MPPC elements has at least a linear dimension less than or equal to half the corresponding linear dimension of the respective collimation channel.

6. The device according to claim 1, wherein said SiPM or MPPC elements are connected to the electronic processing unit independently of each other.

7. The device according to claim 1, wherein the optical guides are independent of each other and applied individually to the respective SiPM or MPPC element or to the scintillation structure.

8. The device according to claim 1, wherein the optical guides are mounted on a shared support which is fixed to a frame of the device.

9. The device according to claim 1, wherein each optoelectronic conversion element is associated with a single respective collimation channel and each collimation channel is associated with a single respective optoelectronic conversion element.

10. The device of claim 2, wherein the scintillation plate is a single scintillation plate that extends on the overall detection area.

11. The device according to claim 2, wherein each SiPM or MPPC element is positioned in a centred position relative to the corresponding collimation channel.

12. The device according to claim 3, wherein each SiPM or MPPC element is positioned in a centred position relative to the corresponding collimation channel.

13. The device according to claim 2, wherein each of said SiPM or MPPC elements has a surface extension of between 1 mm² and 6 mm² and/or wherein each of said SiPM or MPPC elements has at least a linear dimension less than or equal to half the corresponding linear dimension of the respective collimation channel.

14. The device according to claim 3, wherein each of said SiPM or MPPC elements has a surface extension of between 1 mm² and 6 mm² and/or wherein each of said SiPM or MPPC elements has at least a linear dimension less than or equal to half the corresponding linear dimension of the respective collimation channel.

15. The device according to claim 4, wherein each of said SiPM or MPPC elements has a surface extension of between 1 mm² and 6 mm² and/or wherein each of said SiPM or MPPC elements has at least a linear dimension less than or equal to half the corresponding linear dimension of the respective collimation channel.

16. The device according to claim 2, wherein said SiPM or MPPC elements are connected to the electronic processing unit independently of each other.

17. The device according to claim 3, wherein said SiPM or MPPC elements are connected to the electronic processing unit independently of each other.

18. The device according to claim 4, wherein said SiPM or MPPC elements are connected to the electronic processing unit independently of each other.

19. The device according to claim 5, wherein said SiPM or MPPC elements are connected to the electronic processing unit independently of each other.

20. The device according to claim 2, wherein the optical guides are independent of each other and applied individually to the respective SiPM or MPPC element or to the scintillation structure.
